(19) United States
(12) Patent Application Publication
(10) Pub. No.: US 2026/0212794 A1
(43) Pub. Date: Jul. 23, 2026

(54) AUXILIARY PROCESSOR AND ELECTRONIC DEVICE INCLUDING THE SAME

(71) Applicant: SAMSUNG DISPLAY CO., LTD., YONGIN-SI (KR)

(72) Inventors: Woonyong Lim, Yongin-si (KR); Jaehyun Koh, Yongin-si (KR); Dowon Kim, Yongin-si (KR); Minweun Kim, Yongin-si (KR)

(21) Appl. No.: 19/451,008

(22) Filed: Jan. 16, 2026

(30) Foreign Application Priority Data
Jan. 17, 2025 (KR) 10-2025-0007545

(51) Int. Cl. G09G 3/20; G09G 3/32; G09G 3/3233

(52) U.S. Cl. CPC G09G 3/2003; G09G 3/32; G09G 3/3233; G09G 2300/0819; G09G 2310/027; G09G 2320/0233; G09G 2320/0276; G09G 2320/0646; G09G 2320/0673; G09G 2330/021; G09G 2360/16

(57) ABSTRACT

Provided are an auxiliary processor and an electronic device including the same. The auxiliary processor includes a controller configured to receive an input image signal and a control signal including an input digital brightness value and convert the input image signal into a first data signal, a gamma compensator configured to generate a compensated gamma look-up table based on a reference gamma look-up table, a set voltage value, and new compensation parameters, wherein the reference gamma look-up table corresponds to a reference digital brightness value and the new compensation parameters are calculated based on luminance values for each grayscale associated with the input digital brightness value, and a data converter configured to convert the first data signal into a second data signal by using the compensated gamma look-up table. The set voltage value indicates a level of a driving voltage corresponding to the input digital brightness value.

### CROSS-REFERENCE TO RELATED APPLICATION

This U.S. patent application claims priority to Korean Patent Application No. 10-2025-0007545, filed on Jan. 17, 2025, in the Korean Intellectual Property Office, the disclosure of which is incorporated by reference in its entirety herein.

### 1. TECHNICAL FIELD

One or more embodiments are directed to an auxiliary processor and an electronic device including the same.

### 2. DISCUSSION OF RELATED ART

An electronic device may include a display module, a processor, a memory, and a power module. The display module may include a plurality of pixels, a data driver that outputs data voltages to the pixels, a gate driver that outputs gate signals to the pixels, and a plurality of signal lines.

The processor may include a main processor that includes a central processing unit (CPU) and an auxiliary processor that controls the display module. The auxiliary processor may receive a control signal and an image data signal from the main processor, may output a data control signal for controlling the data driver and a gate control signal for controlling the gate driver, may convert an image data signal into a data signal that conforms to the interface specifications of the display module, and may transmit the data signal to the data driver.

However, as display technologies continue to prioritize power efficiency, it has become common to vary the driving voltages applied to pixels based on user-defined brightness levels. However, such voltage adjustments can inadvertently affect the optical characteristics of the display such as luminance consistency, gamma response, and color accuracy potentially leading to a noticeable decline in image quality at certain brightness settings. This creates a technical challenge in maintaining visual performance while achieving lower power consumption.

### SUMMARY

To reduce power consumption of a display module, a driving voltage applied to pixels for each level may change according to a set digital brightness value. However, such changes in driving voltage can alter the optical characteristics of the display, potentially leading to deterioration in image quality. To address this, one or more embodiments provide a technique for compensating changes in optical characteristics based on the driving voltage associated with the input brightness level, thereby helping to maintain consistent display performance.

One or more embodiments include an auxiliary processor configured to compensate for a change in optical characteristics according to a change in driving voltage, and an electronic device including the auxiliary processor. However, this is only an example and the scope of the disclosure is not limited thereby.

Additional aspects will be set forth in part in the description which follows and, in part, will be apparent from the description, or may be learned by practice of the presented embodiments of the disclosure.

According to one or more embodiments, an auxiliary processor includes a controller configured to receive an input image signal and a control signal including an input digital brightness value and convert the input image signal into a first data signal, a gamma compensator configured to generate a compensated gamma look-up table based on a reference gamma look-up table, a set voltage value, and new compensation parameters, wherein the reference gamma look-up table corresponds to a reference digital brightness value and the new compensation parameters are calculated based on luminance values for each grayscale associated with the input digital brightness value, and a data converter configured to convert the first data signal into a second data signal by using the compensated gamma look-up table, wherein the set voltage value indicates a level of a driving voltage corresponding to the input digital brightness value.

In an embodiment, the gamma compensator may include a dimming calculator configured to calculate grayscale values representing luminance of corresponding grayscales at the input digital brightness value by using the reference gamma look-up table, a voltage change sensor configured to calculate a change voltage value by comparing a reference voltage value corresponding to the reference digital brightness value with the set voltage value, a compensation parameter generator configured to generate the new compensation parameters based on the grayscale values, a compensation value generator configured to calculate compensation values based on the new compensation parameters and the change voltage value, and a gamma look-up table generator configured to generate the compensated gamma look-up table based on the grayscale values and the compensation values.

In an embodiment, the compensation parameter generator may be further configured to generate the new compensation parameters corresponding to the grayscale values by using reference compensation parameters prestored in a memory in correspondence with the reference digital brightness value.

In an embodiment, the reference compensation parameters may be generated by using a multi-time program operation at the reference digital brightness value.

In an embodiment, the voltage change sensor may be further configured to calculate an absolute value of a difference between the set voltage value and the reference voltage value as the change voltage value.

In an embodiment, the compensation value generator may be further configured to generate the compensation values by multiplying the new compensation parameters by the change voltage value.

In an embodiment, the gamma look-up table generator may be further configured to generate the compensated gamma look-up table by adding the grayscale values to the compensation values.

According to one or more embodiments, an electronic device includes a display including a plurality of pixels, a memory configured to store reference compensation parameters and a reference gamma look-up table corresponding to a reference digital brightness value, a voltage supply circuit configured to output a driving voltage to the plurality of pixels, based on a set voltage value associated with an input digital brightness value, an auxiliary processor configured to receive an input image signal and a control signal including the input digital brightness value, generate a compensated gamma look-up table based on a reference gamma look-up table, the set voltage value, and new compensation parameters calculated based on luminance values for each grayscale associated with the input digital brightness value, and convert the input image signal into a data signal by using the compensated gamma look-up table, and a data driver configured to output a data voltage corresponding to each of the plurality of pixels, based on the data signal.

In an embodiment, the auxiliary processor may include a controller configured to receive the control signal and the input image signal and convert the input image signal into a first data signal, a gamma compensator configured to generate the compensated gamma look-up table, and a data converter configured to convert the first data signal into the data signal by using the compensated gamma look-up table.

In an embodiment, the gamma compensator may include a dimming calculator configured to calculate grayscale values representing luminance of a corresponding grayscale at the input digital brightness value by using the reference gamma look-up table, a voltage change sensor configured to calculate a change voltage value by comparing a reference voltage value corresponding to the reference digital brightness value with the set voltage value, a compensation parameter generator configured to generate the new compensation parameters based on the grayscale values, a compensation value generator configured to calculate compensation values based on the new compensation parameters and the change voltage value, and a gamma look-up table generator configured to generate the compensated gamma look-up table based on the grayscale values and the compensation values.

In an embodiment, the compensation parameter generator may be further configured to calculate the new compensation parameters corresponding to the grayscale values by using the reference compensation parameters.

In an embodiment, the reference compensation parameters may be generated by using a multi-time program operation at the reference digital brightness value.

In an embodiment, the voltage change sensor may be further configured to calculate an absolute value of a difference between the set voltage value and the reference voltage value as the change voltage value.

In an embodiment, the compensation value generator may be further configured to generate the compensation values by multiplying the new compensation parameters by the change voltage value.

In an embodiment, the gamma look-up table generator may be further configured to generate the compensated gamma look-up table by adding the grayscale values to a corresponding compensation value among the compensation values.

In an embodiment, the plurality of pixels may each include a light-emitting diode including a first electrode and a second electrode, a driving transistor electrically connected between a driving voltage line and the first electrode, and a data write transistor electrically connected between a data line and the driving transistor, and the voltage supply circuit may be configured to output the driving voltage to the second electrode.

In an embodiment, the plurality of pixels may each include a light-emitting diode including a first electrode and a second electrode, a driving transistor connected between a driving voltage line and the first electrode, a data write transistor connected between a data line and the driving transistor, and an initialization transistor connected between an initialization voltage line and the first electrode, and the voltage supply circuit may be configured to output the driving voltage to the initialization voltage line.

In an embodiment, a range between a threshold digital brightness value and the reference digital brightness value may be divided into a plurality of luminance levels, and the set voltage value may be determined based on a corresponding luminance level among the plurality of luminance levels associated with the input digital brightness value.

In an embodiment, the set voltage value may increase as the corresponding luminance level approaches the threshold digital brightness value and may decrease as the corresponding luminance level approaches the reference digital brightness value.

In an embodiment, the electronic device may include an electronic device for displaying an image, a wearable electronic device, or an electronic device for a vehicle.

Other aspects, features, and advantages of the disclosure will become better understood through the accompanying drawings, the appended claims, and the detailed description.

### BRIEF DESCRIPTION OF THE DRAWINGS

The above and other aspects and features of certain embodiments of the disclosure will be more apparent from the following description taken in conjunction with the accompanying drawings, in which:

FIG. 1 is a schematic block diagram of an electronic device according to an embodiment;

FIGS. 2A and 2B are equivalent circuit diagrams of a pixel according to an embodiment;

FIG. 3 is a block diagram schematically illustrating a gamma compensator according to an embodiment;

FIG. 4 is a flowchart of an operation of the gamma compensator according to an embodiment;

FIG. 5 is a diagram illustrating luminance for each grayscale according to a digital brightness value (DBV);

FIG. 6 is a table showing an example of reference compensation parameters according to an embodiment;

FIG. 7 is a table showing an example of new compensation parameters according to an embodiment;

FIG. 8 is a graph showing compensation parameters for each grayscale according to an embodiment;

FIG. 9 is a graph showing compensation parameters for each luminance according to an embodiment;

FIG. 10 is a graph showing a change in driving voltage and a change in optical characteristics of a display module according to a DBV;

FIG. 11 is a block diagram of an electronic device according to an embodiment; and

FIGS. 12 to 14 are schematic diagrams of electronic devices according to various embodiments.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Throughout the disclosure, the expression “at least one of a, b or c” indicates only a, only b, only c, both a and b, both a and c, both b and c, all of a, b, and c, or variations thereof.

As the present description allows for various changes and numerous embodiments, certain embodiments will be illustrated in the drawings and described in detail in the written description. Effects and features of the disclosure, and methods of achieving them will be clarified with reference to embodiments described below in detail with reference to the drawings. However, the disclosure is not limited to the following embodiments and may be embodied in various forms.

Hereinafter, embodiments will be described in detail with reference to the accompanying drawings. When describing embodiments with reference to the accompanying drawings, the same or corresponding elements are denoted by the same reference numerals, and redundant descriptions thereof are omitted.

It will be understood that although the specification, the terms “first,” “second,” etc. may be used herein to describe various elements, these elements should not be limited by these terms. These terms are only used to distinguish one element from another.

The singular forms as used herein are intended to include the plural forms as well unless the context clearly indicates otherwise.

It will be further understood that the terms “include” and/or “comprise” used herein specify the presence of stated features or elements, but do not preclude the presence or addition of one or more other features or elements.

The terms “unit,” “module,” or “block” as used herein may be implemented as software or hardware. According to embodiments, a plurality of units, modules, or blocks may be implemented as a single component, or a single unit, module, or block may include a plurality of components.

It will be further understood that when layers, regions, or elements are referred to as being connected to each other, they may be directly connected to each other or indirectly connected to each other with intervening layers, regions, or elements therebetween. For example, when layers, regions, or elements are referred to as being electrically connected to each other, they may be directly electrically connected to each other or indirectly electrically connected to each other with intervening layers, regions, or elements therebetween.

In the present specification, the expression “A and/or B” indicates only A, only B, or both A and B. The expression “at least one of A and B” indicates only A, only B, or both A and B.

In the disclosure, the x direction, the y direction, and the z direction are not limited to directions along three axes of the orthogonal coordinate system and may be interpreted in a broader sense. For example, the x direction, the y direction, and the z direction may be perpendicular to one another, or may represent different directions that are not perpendicular to one another.

In the disclosure, the terms “on” and “off” used in connection with a state of an element may refer to an activated state of the element and an inactive (or deactivated) state of the element, respectively. The terms “on” and “off” used in connection with a signal received by an element may refer to a signal that activates the element and a signal that deactivates the element, respectively. The element may be activated by a high-level voltage or a low-level voltage. For example, a P-channel transistor (a P-type transistor) is activated by a low-level voltage, and an N-channel transistor (an N-type transistor) is activated by a high-level voltage. Therefore, it will be understood that the “on” voltages for the P-type transistor and the N-type transistor are opposite (low/high) voltage levels.

When a certain embodiment may be implemented differently, a specific process order may be performed differently from the described order. For example, two consecutively described processes may be performed substantially at the same time or performed in an order opposite to the stated order.

One or more embodiments relate to a compensation algorithm for display devices that adjusts for changes in optical characteristics caused by variations in driving voltage (e.g., a second driving voltage VSS and/or initialization voltages) according to an input digital brightness value (DBV). The system uses a set voltage value representing the driving voltage for the input DBV and calculates new compensation parameters based on luminance for each grayscale at that DBV. These parameters are then used to recalculate compensation values and generate a compensated gamma look-up table, enabling consistent display quality across different brightness settings.

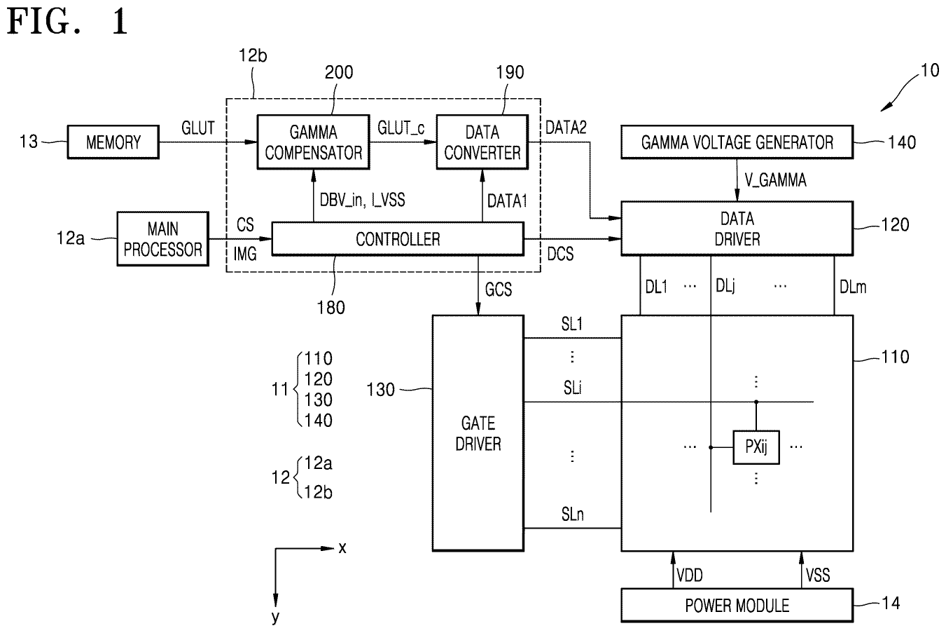

FIG. 1 is a schematic block diagram of an electronic device 10 according to an embodiment.

Referring to FIG. 1, the electronic device 10 may include a display module 11, a processor 12, a memory 13, and a power module 14 (e.g., a power supply).

The display module 11 may include a display 110, a data driver 120 (e.g., a first driver circuit), a gate driver 130 (e.g., a second driver circuit), and a gamma voltage generator 140. The display module 11 may include a display panel including a display area in which an image is displayed and a peripheral area outside the display area.

The display 110 may include a plurality of gate lines SL1, . . . , SLn, a plurality of data lines DL1, . . . , DLm, and a plurality of pixels PXij connected thereto. For example, n and m may each be a natural number greater than 1.

The pixels PXij may be disposed in various forms, such as a stripe arrangement, a PenTile™ arrangement (e.g., a diamond arrangement), or a mosaic arrangement, and may be configured to render an image. The display 110 may define a display area of the display module 11. Each of the pixels PXij may include a light-emitting diode as a display element. The light-emitting diode may be connected to a pixel circuit. The pixel circuit may include a plurality of transistors and at least one capacitor.

The pixels PXij may each be configured to emit red light, green light, or blue light from the light-emitting diode. Alternatively, the pixels PXij may each be configured to emit red light, green light, blue light, or white light from the light-emitting diode. One pixel PXij may be connected to a corresponding gate line SLi among the gate lines SL1, . . . , SLn and a corresponding data line DLj among the data lines DL1, . . . , DLm.

Each of the gate lines SL1, . . . , SLn may extend in a first direction (e.g., an x direction) and may be connected to the pixels PXij disposed in the same row. The gate lines SL1, . . . , SLn may each be configured to transmit a gate signal to the pixels PXij disposed in the same row. The data lines DL1, . . . , DLm may each extend in a second direction (e.g., a y direction) and may each be connected to the pixels PXij disposed in the same column. The data lines DL1, . . . , DLm may each be configured to transmit a data voltage to the pixels PXij disposed in the same column.

The gate driver 130 may be connected to the gate lines SL1, . . . , SLn and may be configured to generate a gate signal in response to a gate control signal GCS output from an auxiliary processor 12b and sequentially supply the gate signal to the gate lines SL1, . . . , SLn. The gate line SLi may be connected to a gate of a transistor included in the pixel circuit of the pixel PXij. The gate signal may be a signal for controlling the turn-on and turn-off of a transistor having a gate connected to the gate line SLi. The gate signal may be a square wave signal including a gate-on voltage that allows the transistor to be turned on and a gate-off voltage that allows the transistor to be turned off. A period during which the gate-on voltage of the gate signal is maintained and a period during which the gate-off voltage of the gate signal is maintained may be determined according to the function of the transistor that receives the gate signal in the pixel PXij.

The data driver 120 may be connected to the data lines DL1, . . . , DLm and may be configured to supply data voltages to the data lines DL1, . . . , DLm in response to a data control signal DCS and a second data signal DATA2, which are output from the auxiliary processor 12b. The gamma voltage generator 140 may be configured to generate gamma voltages V_GAMMA having different voltage levels and output the gamma voltages V_GAMMA to the data driver 120. The data driver 120 may be configured to convert the second data signal DATA2 into an analog data voltage by using the gamma voltages V_GAMMA. The pixels PXij may each be configured to emit light with a grayscale corresponding to the data voltage level of the corresponding data voltage.

The processor 12 may include a main processor 12a and the auxiliary processor 12b. The main processor 12a may include a central processing unit (CPU) or an application processor (AP) configured to control the operation of the electronic device 10. The main processor 12a may be configured to transmit a control signal CS and an input image signal IMG to the auxiliary processor 12b based on input data received from an input module or a sensor module. In an embodiment, the input image signal IMG may include red image data, green image data, and blue image data. In another embodiment, the input image signal IMG may include magenta image data, yellow image data, and cyan image data.

The control signal CS may include an input digital brightness value (DBV), denoted as DBV_in, and a corresponding set voltage value, denoted as I_VSS. In an embodiment, the input DBV DBV_in may be a DBV set by a user. The display module 11 may be configured to emit light based on the set DBV. The DBV may refer to the maximum luminance displayed by the display module 11. For example, the DBV may refer to luminance when the display module 11 displays a grayscale 255 (white). The user may select a DBV in a range between a lowest DBV (e.g., a threshold DBV) and a highest DBV, which may be displayed by the display module 11.

At least one of driving voltages supplied by the power module 14 may change according to the DBV. For example, a range between a threshold DBV and a reference DBV may be divided into a plurality of luminance levels. The power module 14 may be configured to supply a driving voltage based on a luminance level associated with the DBV. In an embodiment, the driving voltage that changes according to the luminance level may be a second driving voltage VSS and/or an initialization voltage. The set voltage value I_VSS may represent a driving voltage level corresponding to a luminance level associated with the input DBV DBV_in.

The auxiliary processor 12b may be a display processor configured to control the display module 11. The auxiliary processor 12b may include a controller 180 (e.g., a controller circuit), a data converter 190 (e.g., a first logic circuit), and a gamma compensator 200 (e.g., a second logic circuit). Each of the controller 180, the data converter 190, and the gamma compensator 200 may refer to a software component or a hardware component, such as a field programmable gate array (FPGA) and an application specific integrated circuit (ASIC). The auxiliary processor 12b may be implemented as a single integrated component (e.g., a single chip), or at least one of the controller 180, the data converter 190, and the gamma compensator 200 may be implemented as an independent component (e.g., a plurality of chips).

The controller 180 may be configured to generate the gate control signal GCS, the data control signal DCS, and a power control signal based on the control signal CS transmitted from the main processor 12a. The controller 180 may be configured to convert the input image signal IMG received from the main processor 12a into a first data signal DATA1, with a data format adapted to factors such as the arrangement of the pixels PXij of the display module 11.

The controller 180 may be configured to control a driving timing of the display module 11 by supplying the data control signal DCS to the data driver 120, supplying the gate control signal GCS to the gate driver 130, and supplying the power control signal to the power module 14. In addition, the controller 180 may be configured to provide the gamma compensator 200 with the input DBV DBV_in and the set voltage value I_VSS included in the control signal CS.

The gamma compensator 200 may be configured to generate a compensated gamma look-up table GLUT_c corresponding to the input DBV DBV_in, based on a reference gamma look-up table GLUT and reference compensation parameters prestored in the memory 13. The reference gamma look-up table GLUT may be prestored in the memory 13 in correspondence with the reference DBV during a process of manufacturing the electronic device 10. The compensated gamma look-up table GLUT_c may be generated based on the luminance for each grayscale at the input DBV DBV_in and the set voltage value corresponding to the input DBV DBV_in. In an embodiment, the reference DBV is a highest DBV that the display module 11 may output. However, the disclosure is not limited thereto, and the reference DBV may be a certain DBV selected from a range between the lowest DBV (e.g., the threshold DBV) and the highest DBV.

The data converter 190 may be configured to convert the first data signal DATA1 into the second data signal DATA2 using the compensated gamma look-up table GLUT_c received from the gamma compensator 200, and to output the second data signal DATA2 to the data driver 120. The data converter 190 may be configured to convert the first data signal DATA1 into the second data signal DATA2 by compensating for the first data signal DATA1 so that the image displayed on the display module 11 has desired optical characteristics according to the optical characteristics of the display module 11 and a user's settings.

The memory 13 may be configured to store a variety of data used by the processor 12 or the display module 11. The memory 13 may be configured to store the reference gamma look-up table GLUT and the reference compensation parameters (or an offset look-up table) required for the operation of the auxiliary processor 12b. The memory 13 may include at least one of volatile memory and non-volatile memory.

The power module 14 may include a voltage supply circuit configured to generate driving voltages for driving the pixels PXij in response to the power control signal from the auxiliary processor 12b. When the pixel PXij includes an organic light-emitting diode as a display element, the power module 14 (or the voltage supply circuit) may be configured to supply a first driving voltage VDD and a second driving voltage VSS to the pixels PXij of the display 110. The first driving voltage VDD may be a voltage provided to a first electrode (e.g., an anode electrode) of the organic light-emitting diode. The second driving voltage VSS may be a voltage provided to a second electrode (e.g., a cathode electrode) of the organic light-emitting diode.

In an embodiment, the power module 14 is configured to supply an initialization voltage to the pixels PXij of the display 110. The initialization voltage may be applied to a gate of the driving transistor of the pixel circuit and/or the first electrode of the organic light-emitting diode. In addition, the power module 14 may be configured to generate a gate-on voltage and a gate-off voltage for controlling a switching transistor of each of the pixels PXij and provide the gate-on voltage and the gate-off voltage to the gate driver 130.

To reduce power consumption, the power module 14 may change the driving voltage based on the set voltage value I_VSS, which corresponds to the luminance level associated with the input DBV DBV_in. A change in the driving voltage may change optical characteristics of the display module 11. The auxiliary processor 12b may be configured to generate the compensated gamma look-up table GLUT_c based on the luminance for each grayscale at the input DBV DBV_in and the corresponding set voltage value, and to compensate the data signal using the compensated gamma look-up table GLUT_c. Accordingly, the electronic device 10 may display a high-quality image with compensated optical characteristics, while maintaining low power consumption.

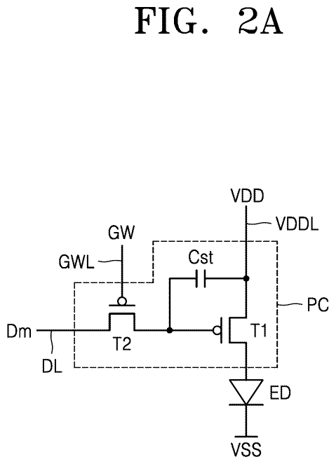

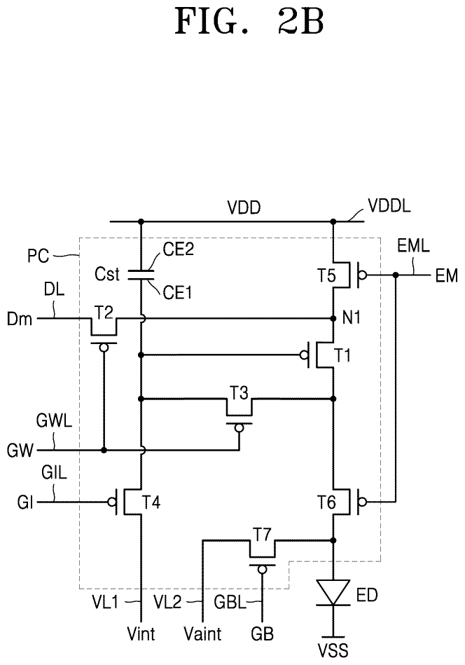

FIGS. 2A and 2B are equivalent circuit diagrams of a pixel according to an embodiment.

Referring to FIG. 2A, the pixel may include a light-emitting diode ED and a pixel circuit PC. The pixel circuit PC may be configured to control the luminance of the light-emitting diode ED. The light-emitting diode ED may be electrically connected to the pixel circuit PC, and the pixel circuit PC may include a first transistor T1, a second transistor T2, and a storage capacitor Cst.

The pixel circuit PC may be electrically connected to signal lines and voltage lines. The signal lines may include a first gate line GWL and a data line DL, and the voltage lines may include a first driving voltage line VDDL.

The second transistor T2, which acts as a data write transistor, may be electrically connected to the first gate line GWL and the data line DL. The first gate line GWL may be configured to provide a first gate signal GW to a gate electrode of the second transistor T2. The second transistor T2 may be configured to transmit, to the first transistor T1, a data voltage Dm input from the data line DL, in response to the first gate signal GW input from the first gate line GWL.

The storage capacitor Cst may be electrically connected to the second transistor T2 and the first driving voltage line VDDL, and may be configured to store a voltage corresponding to the difference between the data voltage Dm received from the second transistor T2 and a first driving voltage VDD supplied through the first driving voltage line VDDL.

The first transistor T1, which acts as a driving transistor, may be configured to control a driving current flowing through the light-emitting diode ED. The first transistor T1 may be connected to the first driving voltage line VDDL and the storage capacitor Cst. The first transistor T1 may be configured to control the driving current flowing from the first driving voltage line VDDL to the light-emitting diode ED according to a voltage value stored in the storage capacitor Cst.

The light-emitting diode ED may be configured to emit light having a certain luminance based on the driving current. A first electrode of the light-emitting diode ED may be electrically connected to the pixel circuit PC and may be configured to receive the driving current. A second electrode of the light-emitting diode ED may be configured to receive the second driving voltage VSS from the power module (see 14 of FIG. 1).

FIG. 2A illustrates that the pixel circuit PC includes two transistors and one storage capacitor, but in another embodiment, the pixel circuit PC may include three or more transistors.

Referring to FIG. 2B, a pixel circuit PC may include a first transistor T1, a second transistor T2, a third transistor T3, a fourth transistor T4, a fifth transistor T5, a sixth transistor T6, a seventh transistor T7, and a storage capacitor Cst.

The pixel circuit PC may be electrically connected to signal lines and voltage lines. The signal lines may include a data line DL, gate lines, such as a first gate line GWL, a second gate line GIL, a third gate line GBL, and an emission control line EML. The voltage lines may include a first initialization voltage line VL1, a second initialization voltage line VL2, and a first driving voltage line VDDL.

The first driving voltage line VDDL may be configured to transmit a first driving voltage VDD to the first transistor T1. The first initialization voltage line VL1 may be configured to transmit, to the pixel circuit PC, a first initialization voltage Vint for initializing a gate of the first transistor T1. The second initialization voltage line VL2 may be configured to transmit, to the pixel circuit PC, a second initialization voltage Vaint for initializing a first electrode of a light-emitting diode ED. In an embodiment, the first initialization voltage Vint and the second initialization voltage Vaint may be the same voltage.

The first transistor T1 may be electrically connected to the first driving voltage line VDDL via the fifth transistor T5 and may be electrically connected to the light-emitting diode ED via the sixth transistor T6. The first transistor T1, which acts as a driving transistor, may be configured to receive a data voltage Dm according to the switching operation of the second transistor T2 and supply a driving current to the light-emitting diode ED.

The second transistor T2, which acts as a data write transistor, may be electrically connected to the first gate line GWL and the data line DL. The second transistor T2 may be electrically connected to the first driving voltage line VDDL via the fifth transistor T5. The second transistor T2 may be configured to be turned on in response to a first gate signal GW received through the first gate line GWL and perform a switching operation to transmit the data voltage Dm received through the data line DL to a first node N1.

The third transistor T3, which acts as a compensation transistor, may be electrically connected to the first gate line GWL and electrically connected between a gate of the first transistor T1 and a drain of the first transistor T1. The third transistor T3 may be configured to be turned on in response to the first gate signal GW received through the first gate line GWL and diode-connect the first transistor T1.

The fourth transistor T4, which acts as a first initialization transistor, may be electrically connected to the second gate line GIL and the first initialization voltage line VL1. The fourth transistor T4 may be configured to be turned on in response to a second gate signal GI received through the second gate line GIL and initialize a gate voltage of the first transistor T1 by transmitting the first initialization voltage Vint from the first initialization voltage line VL1 to the gate of the first transistor T1. In an embodiment, the second gate signal GI may correspond to a scan signal of another pixel circuit disposed in a previous row of the corresponding pixel circuit PC.

The fifth transistor T5 may act as a first emission control transistor and the sixth transistor T6 may act as a second emission control transistor. The fifth transistor T5 and the sixth transistor T6 may be electrically connected to the emission control line EML and configured to turn on simultaneously in response to an emission control signal EM received through the emission control line EML, thereby forming a current path for the driving current to flow from the first driving voltage line VDDL to the light-emitting diode ED.

A first electrode of the light-emitting diode ED may be electrically connected to the first transistor T1 through the sixth transistor T6. A second electrode of the light-emitting diode ED may be configured to receive the second driving voltage VSS from the power module (see 14 of FIG. 1).

The seventh transistor T7, which acts as a second initialization transistor, may be electrically connected to the third gate line GBL, the second initialization voltage line VL2, and the sixth transistor T6. The seventh transistor T7 may be configured to be turned on in response to a third gate signal GB received through the third gate line GBL and initialize the first electrode of the light-emitting diode ED by transmitting the second initialization voltage Vaint from the second initialization voltage line VL2 to the first electrode of the light-emitting diode ED.

The storage capacitor Cst may include a first electrode CE1 and a second electrode CE2. The first electrode CE1 may be electrically connected to the gate of the first transistor T1 and the second electrode CE2 may be electrically connected to the first driving voltage line VDDL. The storage capacitor Cst may store and maintain a voltage corresponding to a difference between the voltage on the first driving voltage line VDDL and the gate voltage of the first transistor T1, thereby maintaining the voltage applied to the gate of the first transistor T1.

In an embodiment, the first to seventh transistors T1 to T7 may each be provided as a P-channel metal-oxide semiconductor field effect transistor (MOSFET) (PMOS). In another embodiment, some of the first to seventh transistors T1 to T7 may each be provided as an N-channel MOSFET (NMOS), and the others may each be provided as a PMOS. In another embodiment, the first to seventh transistors T1 to T7 may each be provided as an NMOS.

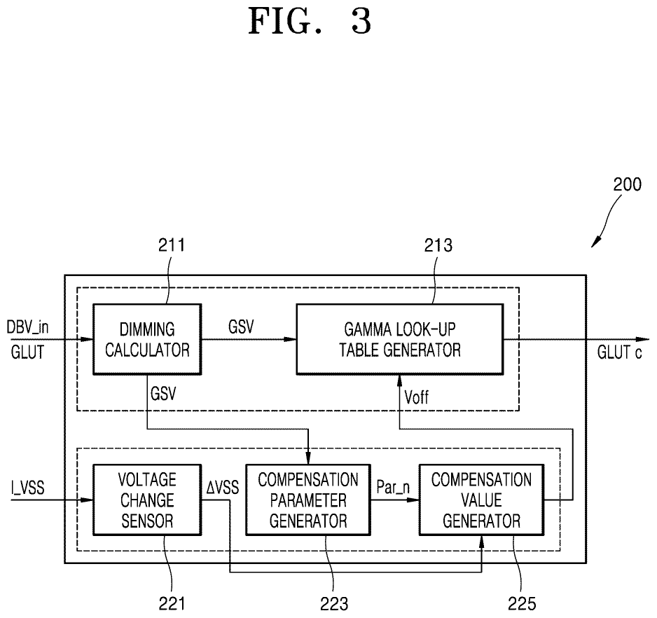

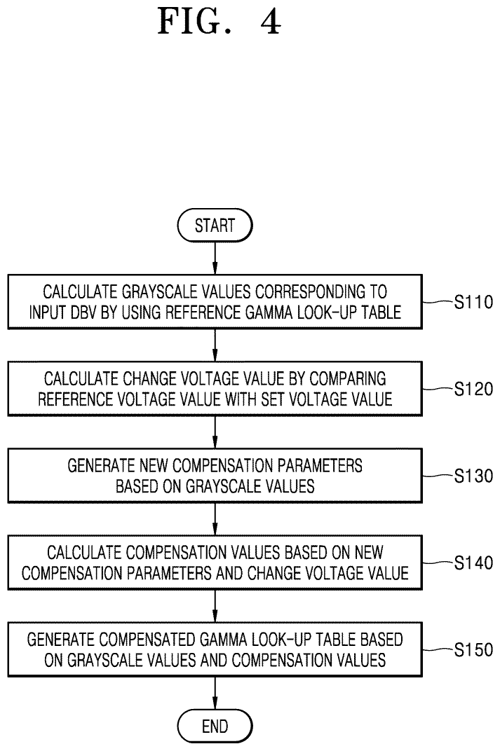

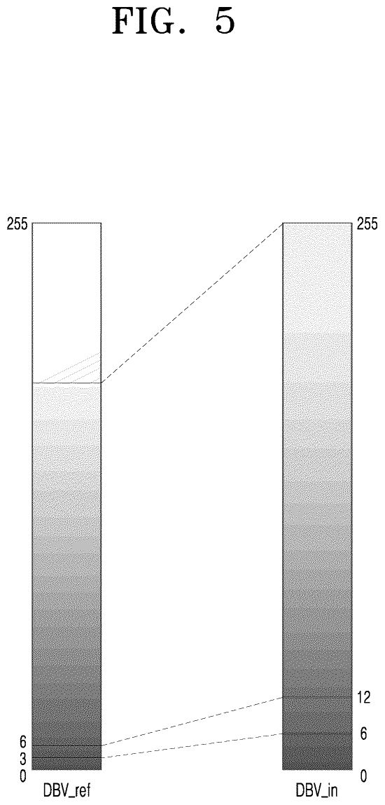

FIG. 3 is a block diagram schematically illustrating the gamma compensator 200 according to an embodiment. FIG. 4 is a flowchart schematically showing the operation of the gamma compensator 200 illustrated in FIG. 3. FIG. 5 is a diagram illustrating luminance for each grayscale according to a DBV.

Referring to FIGS. 3 and 4, the gamma compensator 200 may include a dimming calculator 211 (e.g., a first logic circuit), a gamma look-up table generator 213 (e.g., a second logic circuit), a voltage change sensor 221 (e.g., an analog comparator, a differential amplifier, an analog-to-digital converter with subtraction logic, etc.), a compensation parameter generator 223 (e.g., a third logic circuit), and a compensation value generator 225 (e.g., a fourth logic circuit). Each of the dimming calculator 211, the gamma look-up table generator 213, the voltage change sensor 221, the compensation parameter generator 223, and the compensation value generator 225 may be a software component or a hardware component, such as an FPGA and an ASIC.

The dimming calculator 211 may be configured to calculate grayscale values GSV corresponding to an input DBV DBV_in by using a reference gamma look-up table GLUT prestored in the memory (see 13 of FIG. 1) (step S110).

The reference gamma look-up table GLUT may be prestored in the memory (see 13 of FIG. 1) according to the reference DBV during a process of manufacturing the electronic device (see 10 of FIG. 1). The input DBV DBV_in may be a value less than or equal to a reference DBV DBV_ref.

FIG. 5 schematically illustrates the luminance of the entire grayscale when the reference DBV DBV_ref of the display module (see 11 of FIG. 1) is 500 nit and the input DBV DBV_in is 100 nit. Referring to FIG. 5, a luminance of the 255^{th} graysclae at the reference DBV DBV_ref may have a first luminance and a luminance of a 255^{th} grayscale at the input DBV DBV_in may have a second luminance that is lower than the first luminance.

In an embodiment, the dimming calculator 211 may scale the luminance for each grayscale at the input DBV DBV_in by using the reference gamma look-up table GLUT. The dimming calculator 211 may be configured to generate a scale value s_dbv, which is an integer, by using below Equation 1.

$$s\_dbv = {2}^{j} \times ( DBV\_in \div DBV\_ref ) \qquad [ Equation 1 ]$$

In Equation 1, j represents a dimming resolution and may be 10, 12, 14, or 16. Further in Equation 1, DBV_ref represents the reference DBV DBV_ref and DBV_in represents the input DBV DBV_in. The dimming calculator 211 may be configured to generate a gamma-corrected scale value g_dbv of the input DBV DBV_in, by using below Equation 2.

$$g\_dbv = {( s\_dbv \div {2}^{j} )}^{sc} \times {2}^{j} \qquad [ Equation 2 ]$$

In Equation 2, sc may represent a number that determines how to scale the scale value s_dbv. For example, when sc is 1, the luminance of the input DBV DBV_in may follow a gamma 2.2 correction curve. When sc is 1/2.2, the luminance of the input DBV DBV_in may follow a linear curve. The dimming calculator 211 may obtain a reference value ref_addr[k+n:0] for the luminance of the input DBV DBV_in for each grayscale, by using below Equation 3.

$$ref\_addr [ k + n : 0 ] = addr \times {2}^{n} \times g\_dbv \div {2}^{j} \qquad [ Equation 3 ]$$

In Equation 3, k may represent a grayscale resolution and addr may represent a reference address. In an embodiment, k may be 8, but the disclosure is not limited thereto. For example, k may be an integer greater than 8. The grayscale values GSV corresponding to the input DBV DBV_in may be calculated by using the reference value ref_addr[k+n:0]. The grayscale values GSV may be values indicating the luminance of the corresponding grayscale.

For example, as illustrated in FIG. 5, when the reference DBV DBV_ref is 500 nit and the input DBV DBV_in is 100 nit, a grayscale value GSV of a 6^{th} grayscale at the input DBV DBV_in may be approximately equal to a grayscale value GSV of a 3^{rd} grayscale at the reference DBV DBV_ref. Similarly, a grayscale value GSV of a 12^{th} grayscale at the input DBV DBV_in may be approximately equal to a grayscale value GSV of a 6^{th} grayscale at the reference DBV DBV_ref. This is merely an example to explain the change in the grayscale value GSV according to the DBV, and the disclosure is not limited thereto. The dimming calculator 211 may be configured to output the grayscale values GSV to the gamma look-up table generator 213 and the compensation parameter generator 223.

The voltage change sensor 221 may calculate a change voltage value ΔVSS by comparing a reference voltage value corresponding to the reference DBV DBV_ref with a set voltage value I_VSS corresponding to the input DBV DBV_in (step S120). As described above, the power module 14 may be configured to supply a changed driving voltage corresponding to a luminance level associated with the DBV. The set voltage value I_VSS may represent a driving voltage level associated with a luminance level corresponding to the input DBV DBV_in (or represent a level of a driving voltage corresponding to the input DBV DBV_in). The reference voltage value may indicate the driving voltage level corresponding to a luminance level associated with the reference DBV DBV_ref.

In an embodiment, the power module 14 may change at least one of the second driving voltage VSS, the first initialization voltage Vint, or the second initialization voltage Vaint based on the luminance level. In an embodiment, the driving voltage that changes based on the luminance level may be the second driving voltage VSS that the power module 14 outputs to the second electrode (or the cathode electrode) of the light-emitting diode ED. In another embodiment, the driving voltage that changes based on the luminance level may be the first initialization voltage Vint that the power module 14 outputs to one terminal of the first initialization transistor (i.e., the fourth transistor T4) or the second initialization voltage Vaint that the power module 14 outputs to one terminal of the second initialization transistor (i.e., the seventh transistor T7). Hereinafter, the description will primarily focus on a case in which the power module 14 changes the second driving voltage VSS based on the luminance level.

The reference voltage value may indicate the level of the second driving voltage VSS corresponding to the reference DBV DBV_ref, while the set voltage value I_VSS may indicate the level of the second driving voltage VSS corresponding to the input DBV DBV_in. In an embodiment, the power module 14 may be configured to measure the voltage level of the second driving voltage VSS and generate the set voltage value I_VSS. The power module 14 may be configured to transmit the set voltage value I_VSS to the auxiliary processor 12b. In another embodiment, the memory 13 may be configured to store data representing a relationship between the DBV and the set voltage value I_VSS, and the auxiliary processor 12b may be configured to calculate the set voltage value I_VSS based on the input DBV DBV_in.

The second driving voltage VSS may have a negative value, and its magnitude may decrease (i.e., become more negative) as the DBV increases. For example, the reference voltage value may be less than or equal to the set voltage value I_VSS. The voltage change sensor 221 may be configured to calculate the absolute difference between the set voltage value I_VSS and the reference voltage value, generate this as the change voltage value ΔVSS, which is then output to the compensation value generator 225.

The compensation parameter generator 223 may be configured to generate new compensation parameters Par_n based on the grayscale values GSV at the input DBV DBV_in (step S130). The compensation parameter generator 223 may be configured to set reference compensation parameters corresponding to the grayscale values GSV as the new compensation parameters Par_n for each grayscale at the input DBV DBV_in by using reference compensation parameters prestored in the memory 13. The operation in which the compensation parameter generator 223 generates the new compensation parameters Par_n is described in more detail below with reference to FIGS. 5 to 9.

The compensation value generator 225 may be configured to calculate compensation values Voff for each grayscale at the input DBV DBV_in, based on the new compensation parameters Par_n and the change voltage value ΔVSS (step S140). In an embodiment, the compensation value generator 225 may be configured to generate compensation values Voff by multiplying the new compensation parameters Par_n by the change voltage value ΔVSS. The compensation value generator 225 may be configured to transmit the compensation values Voff to the gamma look-up table generator 213. The compensation values Voff may include values respectively corresponding to a red pixel, a blue pixel, and a green pixel.

The gamma look-up table generator 213 may be configured to generate a compensated gamma look-up table GLUT_c, based on the grayscale values GSV and the compensation values Voff (step S150). For example, the gamma look-up table generator 213 may be configured to generate the compensated gamma look-up table GLUT_c by adding the grayscale values GSV to the compensation values Voff. For instance, if a grayscale value GSV is 120 and the corresponding compensation value Voff is −5, the resulting compensated gamma value would be 115. This calculation may be performed for each grayscale level to construct the full compensated table, ensuring consistent luminance despite changes in driving voltage.

Because the gamma compensator 200 may recalculate the grayscale values GSV of the input DBV DBV_in by using a data dimming process, the electronic device 10 including the auxiliary processor 12b in at least one embodiment may be configured to display the full range of the DBV by using a small number of gamma look-up tables. In addition, when the compensation values Voff are calculated based on the change voltage value ΔVSS and the new compensation parameters Par_n calculated based on the grayscale values GSV at the input DBV DBV_in, there is no need to store compensation values measured from a plurality of DBVs. Therefore, the luminance error due to the change in driving voltage may be reduced while reducing the size of memory.

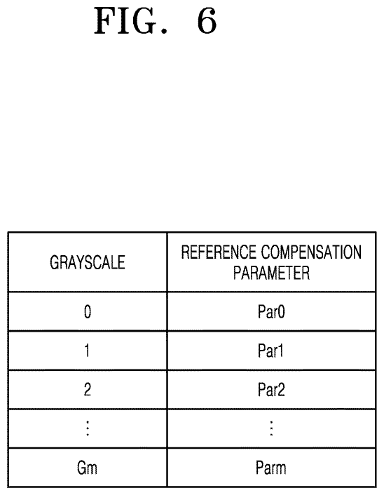

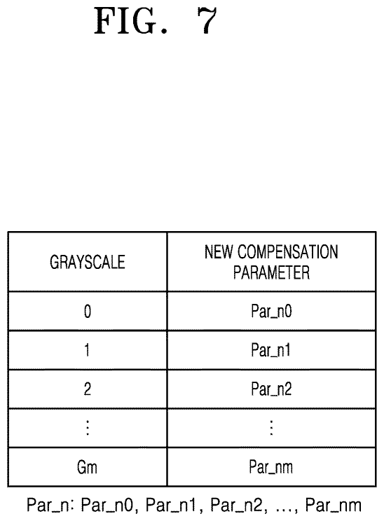

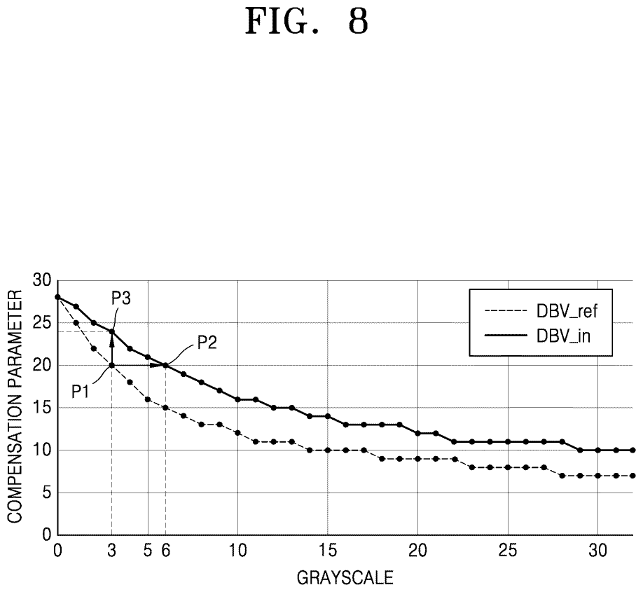

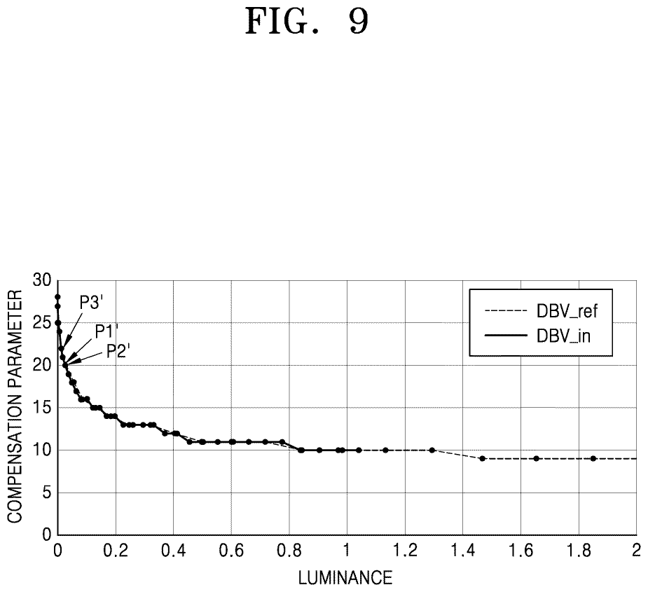

FIG. 6 is a table showing an example of the reference compensation parameters according to an embodiment. FIG. 7 is a table showing an example of the new compensation parameters according to an embodiment. FIG. 8 is a graph showing the compensation parameters for each grayscale according to an embodiment. FIG. 9 is a graph showing the compensation parameters for each luminance according to an embodiment.

Referring to FIGS. 3 and 6 to 9, the compensation parameter generator 223 may be configured to calculate the compensation parameters for each of the grayscale values GSV by using reference compensation parameters Par0, Par1, . . . , Parm prestored in the memory (see 13 of FIG. 1) according to the reference DBV DBV_ref and set the compensation parameters as the new compensation parameters Par_n of the input DBV DBV_in (i.e., generate the new compensation parameters Par_n corresponding to the grayscale values GSV).

Referring to FIG. 6, the memory (see 13 of FIG. 1) may be configured to store the reference compensation parameters Par0, Par1, . . . , Parm generated according to the reference DBV DBV_ref. In the process of manufacturing the display module (see 11 of FIG. 1), the reference compensation value (or the compensation offset) for the entire range of the grayscale values GSV at the reference DBV DBV_ref may be generated by taking into account characteristics of the display panel. The reference compensation parameters Par0, Par1, . . . , Parm may be generated by using a multi-time program operation at the reference DBV DBV_ref. For example, the reference compensation values for each grayscale may be generated by using a multi-time program operation that sets the display module (see 11 of FIG. 1) to the reference DBV DBV_ref and repeatedly corrects the luminance and/or color coordinates of the display module (see 11 of FIG. 1). The reference compensation parameters Par0, Par1, . . . , Parm may be calculated from the measured compensation values and prestored in the memory (see 13 of FIG. 1). In an embodiment, the multi-time program operation is an iterative calibration process in which the display output is measured and adjusted multiple times to match a desired target. For instance, if the measured luminance for a particular grayscale is lower than expected, the system may incrementally adjust the pixel driving conditions such as increasing the voltage or modifying the gamma value over several cycles until the output reaches the target level. The resulting adjustment values for each grayscale may be stored as the reference compensation parameters Par0, Par1, . . . , Parm, which may be later used to generate new compensation parameters at different brightness levels.

In an embodiment, when the grayscale has a value between 0 and m, the first reference compensation parameter Par0 corresponding to the grayscale 0, the second reference compensation parameter Par1 corresponding to the grayscale 1, and the (m+1)^{th} reference compensation parameter Parm corresponding to the grayscale m may be generated. In an embodiment, (m+1) may be 2^{k}, where k is the grayscale resolution. In an embodiment, k may be a natural number greater than or equal to 8. The reference compensation parameters Par0, Par1, . . . , Parm may be stored in the memory (see 13 of FIG. 1) in the form of an offset look-up table. In an embodiment, the reference compensation parameters Par0, Par1, . . . , Parm may include compensation parameters respectively corresponding to a red pixel, a blue pixel, and a green pixel.

Referring to FIG. 7, the compensation parameter generator 223 may be configured to generate the new compensation parameter Par_n for each grayscale at the input DBV DBV_in. In an embodiment, when the grayscale has a value between 0 and m, a first new compensation parameter Par_n0 corresponding to a grayscale 0, a second new compensation parameter Par_n1 corresponding to a grayscale 1, and an (m+1)^{t}h new compensation parameter Par_nm corresponding to a grayscale Gm may be generated. In an embodiment, (m+1) may be 2^{k}, where k is the grayscale resolution. In an embodiment, k may be a natural number greater than or equal to 8.

As described with reference to FIG. 5, the dimming calculator 211 may be configured to calculate the grayscale values GSV according to the input DBV DBV_in. For example, when the reference DBV DBV_ref is 500 nit and the input DBV DBV_in is 100 nit, a grayscale value GSV of the 6^{th} grayscale at the input DBV DBV_in may be approximately equal to a grayscale value GSV of the 3^{rd} grayscale at the reference DBV DBV_ref. However, this example is provided to merely illustrate how the grayscale value GSV may vary with the DBV, but the disclosure is not limited thereto.

FIGS. 8 and 9 illustrate, by way of example, reference compensation parameters when the reference DBV DBV_ref of the display module (see 11 of FIG. 1) is 500 nit and new compensation parameters when the input DBV DBV_in is 100 nit. FIGS. 8 and 9 are provided to illustrate the relationship between the compensation parameter and the grayscale, and between the compensation parameter and the luminance, respectively, but the disclosure is not limited thereto. A relationship between the compensation parameter and the grayscale and a relationship between the compensation parameter and the luminance may vary depending on characteristics of the display panel.

Referring to FIG. 8, a first point P1 represents a compensation parameter of the 3^{rd} grayscale at the reference DBV DBV_ref, a second point P2 represents a compensation parameter of the 6^{th} grayscale at the input DBV DBV_in, and a third point P3 represents a compensation parameter of the 3^{rd} grayscale at the input DBV DBV_in.

Because the luminance of the 3^{rd} grayscale at the reference DBV DBV_ref is different from the luminance of the 3^{rd} grayscale at the input DBV DBV_in, a luminance error may occur when the compensation value is calculated by directly applying the reference compensation parameter of the 3^{rd} grayscale at the reference DBV DBV_ref to the corresponding compensation parameter at the input DBV DBV_in. Accordingly, the compensation parameter generator 223 may be configured to generate the compensation parameters based on the grayscale values GSV associated with the input DBV DBV_in, as these values indicate the actual luminance of each grayscale level under the given brightness condition, rather than relying solely on grayscale indices. Therefore, some grayscales at the input DBV DBV_in may correspond to different luminance values than at the reference DBV DBV_ref, and as a result, the compensation parameters determined for those grayscale levels may differ from the corresponding reference compensation parameters.

Referring to FIG. 9, a 1′ point P1′ represents the compensation parameter of the 3^{rd} grayscale at the reference DBV DBV_ref, a 2′ point P2′ represents the compensation parameter of the 6^{th} grayscale at the input DBV DBV_in, and a 3′ point P3′ represents the compensation parameter of the 3^{rd} grayscale at the input DBV DBV_in. The luminance of the 3^{rd} grayscale at the reference DBV DBV_ref may be approximately equal to the luminance of the 6^{th} grayscale at the input DBV DBV_in. The grayscale value GSV of the 6^{th} grayscale at the input DBV DBV_in may be approximately equal to the grayscale value GSV of the 3^{rd} grayscale at the reference DBV DBV_ref.

The compensation parameter generator 223 may be configured to generate the new compensation parameter by using the grayscale value GSV. The compensation parameter generator 223 may be configured to generate the new compensation parameters corresponding to the grayscale values of the input DBV DBV_in by using the reference compensation parameters. For example, when the grayscale value GSV of the 6^{th} grayscale at the input DBV DBV_in is approximately equal to the grayscale value GSV of the 3^{rd} grayscale at the reference DBV DBV_ref, the compensation parameter generator 223 may be configured to generate the new compensation parameter of the 6^{th} grayscale at the input DBV DBV_in to be approximately equal to the reference compensation parameter of the 3^{rd} grayscale at the reference DBV DBV_ref. The luminance (or the grayscale value GSV) of the 3^{rd} grayscale at the input DBV DBV_in may have a value between the luminance (or the grayscale value) of the 1^{st} grayscale and the luminance (or the grayscale value) of the 2^{nd} grayscale at the reference DBV DBV_ref. In an embodiment, the new compensation parameters may be generated by interpolating adjacent reference compensation parameters. For example, if the grayscale value at the input DBV_in corresponds to a luminance between that of grayscale 1 and grayscale 2 at the reference DBV DBV_ref, and the reference compensation parameters are Par1=4 and Par2=6, then the compensation parameter generator 223 may calculate the new compensation parameter as an interpolated value, e.g., Par_n=5, depending on the relative position of the input grayscale value between those two reference points.

As a comparative example, an electronic device may store a plurality of offset look-up tables in a memory. Each of the offset look-up tables may be generated by using multi-time program operations at different DBVs. In this case, multiple multi-time program operations are required, which may increase the time required to measure the compensation value of the display module. In addition, the size of the memory may increase so as to store a plurality of offset look-up tables.

Because the gamma compensator (see 200 of FIG. 1) according to an embodiment generates the new compensation parameters Par_n of the input DBV DBV_in by using the reference compensation parameters set for the reference DBV DBV_ref, the luminance error of the entire DBV interval may be effectively reduced while reducing the number of multi-time program operations. In addition, the size of the memory may be reduced.

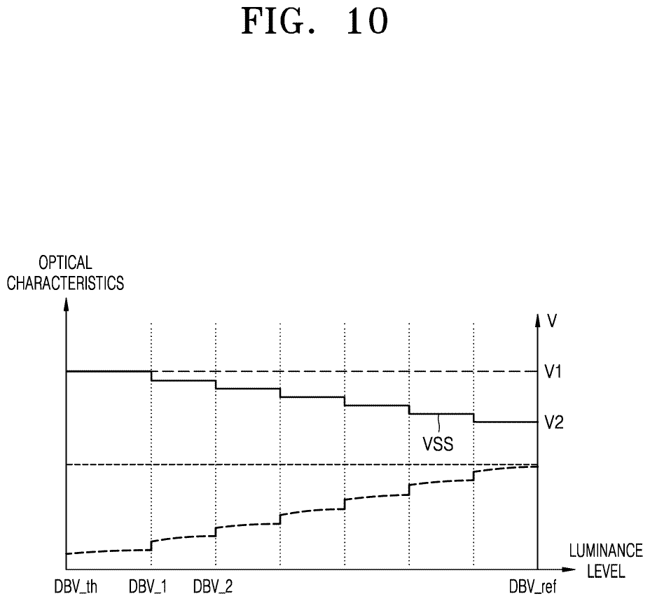

FIG. 10 is a graph showing a change in driving voltage and a change in optical characteristics of a display module according to a DBV.

Referring to FIG. 10, the DBV of the display module (see 11 of FIG. 1) may change in a range between a threshold DBV DBV_th and the reference DBV DBV_ref. The range between the threshold DBV DBV_th and the reference DBV DBV_ref may be divided into a plurality of luminance levels, and the power module (see 14 of FIG. 1) may change the driving voltage according to the luminance level. In an embodiment, the power module (see 14 of FIG. 1) may change at least one of the second driving voltage VSS, the first initialization voltage Vint, or the second initialization voltage Vaint based on the luminance level. For example, if the threshold DBV is set to 20 and the reference DBV is set to 255, the range may be divided into 5 luminance levels: 20-59, 60-99, 100-139, 140-199, and 200-255. If the current DBV is 85 (falling in the second level), the power module may adjust the second driving voltage VSS to −1.8V, while for DBV 200 (in a higher level), the second driving voltage VSS may be adjusted to −2.5V. This is merely one example, and the specific division of luminance levels and voltage values may vary depending on the design and requirements of the display system.

FIG. 10 shows a change in optical characteristics when the display module (see 11 of FIG. 1) changes the DBV from the threshold DBV DBV_th to the reference DBV DBV_ref when displaying the same grayscale, for example, a grayscale corresponding to white. The power module (see 14 of FIG. 1) may change the second driving voltage VSS according to the luminance level. The optical characteristics of the display module (see 11 of FIG. 1) may include a gamma value and a minimum perceptible color difference (MPCD) value.

As the DBV approaches the threshold DBV DBV_th, the second driving voltage VSS may have a higher value, and as the DBV approaches the reference DBV DBV_ref, the second driving voltage VSS may have a lower value. An interval between the threshold DBV DBV_th and the first DBV DBV_1 may be defined as a first luminance level, and an interval between the first DBV DBV_1 and the second DBV DBV_2 may be defined as a second luminance level. In the first luminance level, the power module (see 14 of FIG. 1) may be configured to output the second driving voltage VSS of the first voltage level V1, and in the second luminance level, the power module (see 14 of FIG. 1) may be configured to output the second driving voltage VSS of a level that is lower than the first voltage level V1. Because the voltage level of the second driving voltage VSS changes at the first DBV DBV_1, optical characteristics of the display module (see 11 of FIG. 1) may change rapidly. Therefore, compensation that takes into account the change in the second driving voltage VSS when the luminance level changes may be needed to prevent deterioration of image quality.

When the power module (see 14 of FIG. 1) outputs the second driving voltage VSS of a second voltage level V2 at the reference DBV DBV_ref, the change voltage value ΔVSS may be the absolute value of the difference between the first voltage level V1 and the second voltage level V2. The gamma compensator (see 200 of FIG. 1) according to an embodiment may be configured to calculate the compensation values Voff by multiplying the new compensation parameters Par_n by the change voltage value ΔVSS and generate the compensated gamma look-up table GLUT_c based on the calculated compensation values Voff, so that the display module (see 11 of FIG. 1) may be compensated by taking into account the change in the voltage level of the driving voltage. Accordingly, the electronic device (see 10 of FIG. 1) including the auxiliary processor (see 12b of FIG. 1), according to an embodiment, may effectively reduce the luminance error in the entire range of the DBV without having to prestore an offset look-up table according to the driving voltage for each luminance level in the memory (see 13 of FIG. 1).

The auxiliary processor (see 12b of FIG. 1) according to an embodiment may be applied to various electronic devices. The electronic device according to an embodiment may include the auxiliary processor (see 12b of FIG. 1) described above and may further include, in addition to the display module (see 11 of FIG. 1), modules or devices having other additional functions.

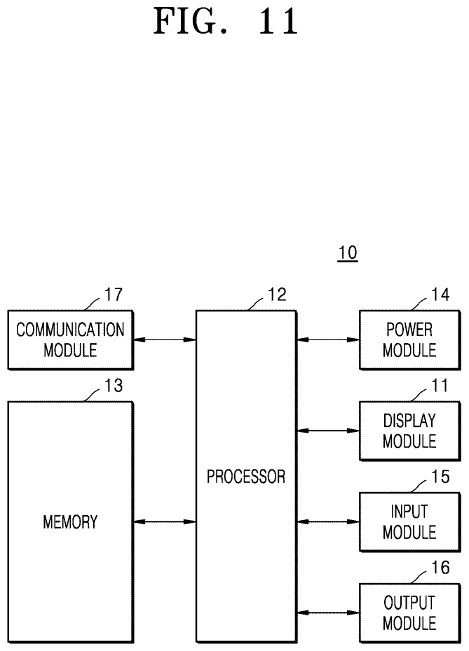

FIG. 11 is a block diagram of an electronic device 10 according to an embodiment.

Referring to FIGS. 1 and 11, the electronic device 10 according to an embodiment may include a display module 11, a processor 12, a memory 13, and a power module 14.

The processor 12 may include at least one of a CPU, an AP, a graphics processing unit (GPU), a communication processor (CP), an image signal processor (ISP), or a controller. In an embodiment, the processor 12 may be functionally or structurally divided into two or more parts. For example, the processor 12 may include a main processor (see 12a of FIG. 1) in the form of a first driving chip including a CPU, and an auxiliary processor (see 12b of FIG. 1) in the form of a second drive chip including a controller (see 180 of FIG. 1) configured to receive an input image signal from the main processor (see 12a of FIG. 1) and process the input image signal to conform to the interface specifications of the display module 11.

Data information used for the operation of the processor 12 or the display module 11 may be stored in the memory 13. The memory 13 may be configured to store the reference gamma look-up table GLUT and the offset look-up table required for the operation of the auxiliary processor 12b. When the processor 12 executes an application stored in the memory 13, an input image signal and/or a control signal may be transmitted to the display module 11, and the display module 11 may process the received signal and output image information on the display (see 110 of FIG. 1).

The power module 14 may include a power supply module, such as a power adapter or a battery device, and a power conversion module configured to convert power supplied by the power supply module to generate power required for the operation of the electronic device 10. The power module 14 may include a power management integrated circuit configured to output voltages required to drive the display module 11.

The electronic device 10 may further include an input module 15, an output module 16, and/or a communication module 17.

The input module 15 may be configured to provide input information to the processor 12 and/or the display module 11. The input module 15 may include a physical button, a keyboard, a microphone, and various sensor modules. Examples of the sensor modules may include a touch sensor, a pressure sensor, a distance sensor, a position sensor, a digitizer, a motion recognition sensor, a camera sensor, a light-receiving sensor, a photoelectric conversion sensor, a temperature sensor, and a biometric sensor, such as a blood pressure sensor, a blood sugar sensor, an electrocardiogram sensor, or a heart rate sensor.

The output module 16 may be configured to receive non-image information other than the image transmitted from the processor 12 and provide the non-image information to a user. Examples of the output module 16 may include an acoustic module, a haptic module, a light-emitting module, etc., and may include other functional modules unique to the electronic device (e.g., a cooling module of a refrigerator, etc.).

The communication module 17 may be a module responsible for transmitting and receiving information between the electronic device 10 and an external device and may include a receiver and a transmitter. The communication module 17 may include various wireless communication modules, such as a mobile communication module, a Wi-Fi™ module, or a Bluetooth module, and various wired communication modules.

At least one of the components of the electronic device 10 may be included in the display module 11 according to the embodiments described above. Furthermore, some of the individual modules functionally included in a single module may be included in the display module 11, and others thereof may be provided separately from the display module 11. In an embodiment, the display module 11 may include a display panel, and each of the auxiliary processor 12b, the memory 13, and the power module 14 may be mounted on the display panel. In another embodiment, each of the main processor 12a, the memory 13, and the power module 14 may be provided in the form of a device other than the display device within the electronic device 10.

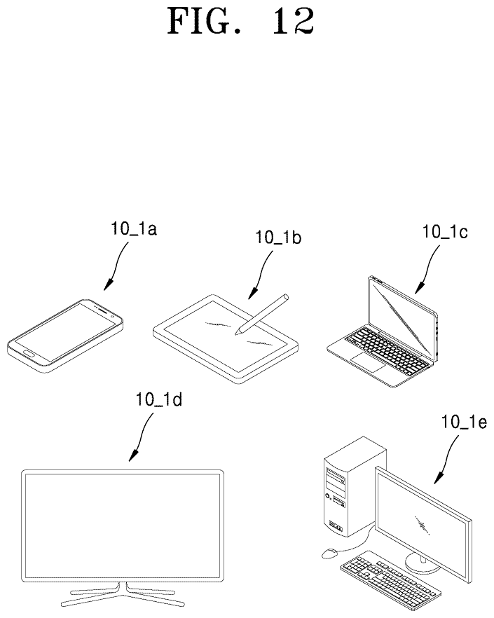

FIGS. 12 to 14 are schematic diagrams of electronic devices according to various embodiments. FIGS. 12 to 14 illustrate examples of various electronic devices to which the display module according to embodiments is applied.

FIG. 12 illustrates examples of the electronic device, including a smartphone 10_1a, a tablet personal computer (PC) 10_1b, a laptop 10_1c, a television (TV) 10_1d, and a desk monitor 10_1e.

The smartphone 10_1a may include, in addition to a display module, a communication module and an input module, such as a touch sensor. The smartphone 10_1a may be configured to process information received through the communication module or another input module and display the information on the display module of the display device.

Similar to the smartphone 10_1a, each of the tablet PC 10_1b, the laptop 10_1c, the TV 10_1d, and the desk monitor 10_1e may include a display module and an input module and, in some cases, may further include a communication module.

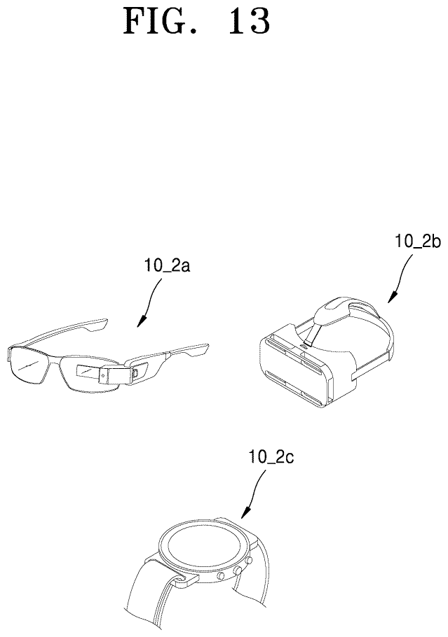

FIG. 13 illustrates examples in which an electronic device including a display module is applied to a wearable electronic device. The wearable electronic device may be smart glasses 10_2a, a head mounted display 10_2b, a smart watch 10_2c, etc.

Each of the smart glasses 10_2a and the head mounted display 10_2b may include a display module configured to display a display image and a reflector configured to provide the display image to the user's eyes by reflecting the displayed display image, and may provide a virtual reality or augmented reality screen to the user through the display module and the reflector.

The smart watch 10_2c may include a biometric sensor as an input module and may be configured to provide biometric information recognized by the biometric sensor to the user through the display module.

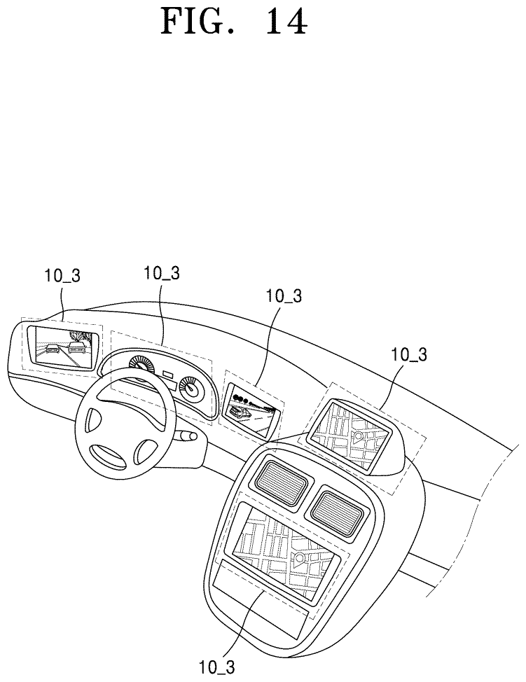

FIG. 14 illustrates an example in which an electronic device including a display module is applied to a vehicle. For example, an electronic device 103 may be applied to dashboards, center fascia, etc. of automobiles, or may be applied to center information displays (CIDs) on dashboards of automobiles or room mirror displays replacing side mirrors.

The electronic device to which the display device according to embodiments is applied may include screen display-oriented devices, such as billboards, electronic boards, or game consoles, and various home appliances that display information through display modules, such as refrigerators, washing machines, dryers, air conditioners, or robot vacuum cleaners. In addition, when the display module has a function of transmitting light, the display module may be applied to electronic devices, such as a smart window or a transparent display device that display a background and a display image together. The types of electronic devices according to embodiments are not limited to those described above, and application of various other electronic devices not described herein may also be possible.

According to an embodiment as described above, an auxiliary processor configured to compensate for a change in optical characteristics according to a change in driving voltage and an electronic device including the auxiliary processor may be implemented. An electronic device including an auxiliary processor according to an embodiment may display high-quality images with low power consumption. However, the scope of the disclosure is not limited by such an effect.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. An auxiliary processor comprising:
a controller configured to receive an input image signal and a control signal including an input digital brightness value and convert the input image signal into a first data signal;
a gamma compensator configured to generate a compensated gamma look-up table based on a reference gamma look-up table, a set voltage value, and new compensation parameters, wherein the reference gamma look-up table corresponds to a reference digital brightness value, and the new compensation parameters are calculated based on luminance values for each grayscale associated with the input digital brightness value; and
a data converter configured to convert the first data signal into a second data signal by using the compensated gamma look-up table,
wherein the set voltage value indicates a level of a driving voltage corresponding to the input digital brightness value.

2. The auxiliary processor of claim 1, wherein the gamma compensator comprises:
a dimming calculator configured to calculate grayscale values representing luminance of corresponding grayscales at the input digital brightness value by using the reference gamma look-up table;
a voltage change sensor configured to calculate a change voltage value by comparing a reference voltage value corresponding to the reference digital brightness value with the set voltage value;
a compensation parameter generator configured to generate the new compensation parameters based on the grayscale values;
a compensation value generator configured to calculate compensation values based on the new compensation parameters and the change voltage value; and
a gamma look-up table generator configured to generate the compensated gamma look-up table based on the grayscale values and the compensation values.

3. The auxiliary processor of claim 2, wherein the compensation parameter generator is further configured to generate the new compensation parameters corresponding to the grayscale values, by using reference compensation parameters prestored in a memory in correspondence with the reference digital brightness value.

4. The auxiliary processor of claim 3, wherein the reference compensation parameters are generated by using a multi-time program operation at the reference digital brightness value.

5. The auxiliary processor of claim 2, wherein the voltage change sensor is further configured to calculate an absolute value of a difference between the set voltage value and the reference voltage value as the change voltage value.

6. The auxiliary processor of claim 2, wherein the compensation value generator is further configured to generate the compensation values by multiplying the new compensation parameters by the change voltage value.

7. The auxiliary processor of claim 2, wherein the gamma look-up table generator is further configured to generate the compensated gamma look-up table by adding the grayscale values to the compensation values.

8. An electronic device comprising:
a display comprising a plurality of pixels;
a memory configured to store reference compensation parameters and a reference gamma look-up table corresponding to a reference digital brightness value;
a voltage supply circuit configured to output a driving voltage to the plurality of pixels based on a set voltage value associated with an input digital brightness value;
an auxiliary processor configured to receive an input image signal and a control signal including the input digital brightness value, generate a compensated gamma look-up table based on the reference gamma look-up table, the set voltage value, and new compensation parameters calculated based on luminance values for each grayscale associated with the input digital brightness value, and convert the input image signal into a data signal by using the compensated gamma look-up table; and
a data driver configured to output a data voltage corresponding to each of the plurality of pixels, based on the data signal.

9. The electronic device of claim 8, wherein the auxiliary processor comprises:
a controller configured to receive the control signal and the input image signal and convert the input image signal into a first data signal;
a gamma compensator configured to generate the compensated gamma look-up table; and
a data converter configured to convert the first data signal into the data signal, by using the compensated gamma look-up table.

10. The electronic device of claim 9, wherein the gamma compensator comprises:
a dimming calculator configured to calculate grayscale values representing luminance of corresponding grayscales at the input digital brightness value, by using the reference gamma look-up table;
a voltage change sensor configured to calculate a change voltage value by comparing a reference voltage value corresponding to the reference digital brightness value with the set voltage value;
a compensation parameter generator configured to generate the new compensation parameters based on the grayscale values;
a compensation value generator configured to calculate compensation values based on the new compensation parameters and the change voltage value; and
a gamma look-up table generator configured to generate the compensated gamma look-up table based on the grayscale values and the compensation values.

11. The electronic device of claim 10, wherein the compensation parameter generator is further configured to calculate the new compensation parameters corresponding to the grayscale values, by using the reference compensation parameters.

12. The electronic device of claim 11, wherein the reference compensation parameters are generated by using a multi-time program operation at the reference digital brightness value.

13. The electronic device of claim 10, wherein the voltage change sensor is further configured to calculate an absolute value of a difference between the set voltage value and the reference voltage value as the change voltage value.

14. The electronic device of claim 10, wherein the compensation value generator is further configured to generate the compensation values by multiplying the new compensation parameters by the change voltage value.

15. The electronic device of claim 10, wherein the gamma look-up table generator is further configured to generate the compensated gamma look-up table by adding the grayscale values to a corresponding compensation value among the compensation values.

16. The electronic device of claim 8, wherein the plurality of pixels each comprise:
a light-emitting diode comprising a first electrode and a second electrode;
a driving transistor connected between a driving voltage line and the first electrode; and
a data write transistor connected between a data line and the driving transistor,
wherein the voltage supply circuit is configured to output the driving voltage to the second electrode.

17. The electronic device of claim 8, wherein the plurality of pixels each comprise:
a light-emitting diode comprising a first electrode and a second electrode;
a driving transistor electrically connected between a driving voltage line and the first electrode;
a data write transistor electrically connected between a data line and the driving transistor; and
an initialization transistor electrically connected between an initialization voltage line and the first electrode,
wherein the voltage supply circuit is configured to output the driving voltage to the initialization voltage line.

18. The electronic device of claim 8, wherein a range between a threshold digital brightness value and the reference digital brightness value is divided into a plurality of luminance levels, and
the set voltage value is determined based on a corresponding luminance level among the plurality of luminance levels associated with the input digital brightness value.

19. The electronic device of claim 18, wherein the set voltage value increases as the corresponding luminance level approaches the threshold digital brightness value, and decreases as the corresponding luminance level approaches the reference digital brightness value.

20. The electronic device of claim 8, wherein the electronic device comprises an electronic device for displaying an image, a wearable electronic device, or an electronic device for a vehicle.
